(19) United States
(12) Patent Application Publication
(10) Pub. No.: US 2006/0149715 A1
(43) Pub. Date: Jul. 6, 2006

(54) SYSTEM AND METHOD FOR IMPROVING A PTO

(76) Inventor: Jerome Glasser, Maplewood, NJ (US)

Correspondence Address: JEROME GLASSER, 16 SUNSET TERRACE, MAPLEWOOD, NJ, 07040, US

(21) Appl. No.: 11/162,852

(22) Filed: Sep. 26, 2005

Related U.S. Application Data
(60) Provisional application No. 60/612,759, filed on Sep. 24, 2004.

(51) Int. Cl. G06F 17/30

(52) U.S. Cl. 707/3

(57) ABSTRACT

The present disclosure relates to a system and method for achieving enhanced operations of an entity, traditionally an authorized governmental body which regulates, assigns, and monitors the registration of intellectual property rights, and particularly relates to the Patent and Trademark Office whose operating scope encompasses the United States of America.

### PRIORITY CLAIM

This Non-Provisional U.S. Patent Application claims priority to and incorporates by reference U.S. Provisional Patent Application No. 60/612,759 filed Sep. 24, 2004.

### FIELD OF THE DISCLOSURE

The present disclosure relates to the enhancement of procedures within an entity, traditionally an authorized governmental body, which regulates, assigns, and monitors the registration of intellectual property rights, and particularly relates to the Patent and Trademark Office whose operating scope encompasses the United States of America.

### BACKGROUND OF THE DISCLOSURE

The United States Patent and Trademark Office (“USPTO”) is a spectacular governmental body, one charged with operating a complex regulatory system the decisions of which have enormous impact on corporations and individuals worldwide. Undeniably, its responsibilities are onerous. An efficient PTO is a vital element in the smooth functioning of any Capitalist system. In the USA, the entire foundation of the “American Dream” owes its stability largely to the existence, proper functioning, and support of the USPTO. Without the existence of a PTO and its dedicated employees, the American hope that an individual can go from “rags to riches” based on his or her imagination, creativity and efforts could and would never have developed. It could be credibly argued that without the existence of the USPTO or an efficient USPTO, the nature of the American people would be entirely different—certainly inferior—to the innovative, superlative character which identifies Americans today. Accordingly, USPTO employees, whose decisions materially affect the lives of applicants directly, and millions of others indirectly, should receive a higher-degree of deserved recognition and appreciation than they currently enjoy.

Anyone who has had even the slightest exposure to the operations of the USPTO is aware of the huge responsibilities faced by those who are charged with maintaining the smooth functioning of a PTO. There are literally millions of well-thought out procedures that must be followed in order to ensure the fair execution of the decisions and operations of this essential and important office. With so complex a system having so many regulations, it is reasonable to expect that not every aspect of every procedure could have been fine-tuned by now to achieve maximum fairness and efficiency. Therefore, it is not surprising that positive changes can still be developed which can further improve the already substantially great systems and methods of the USPTO.

Nevertheless, the system and method of this disclosure has never before been implemented or even contemplated. The method of this disclosure is relatively easy to put into effect and provides for significant enhancements to a PTO, as well as substantial new revenues. This can be of special importance to the USPTO since its operating funds are derived from fees charged to those who interact with this government-sanctioned regulatory body. It would seem reasonable, therefore, that increasing the revenues of a PTO through implementation of the system and method of this disclosure would be important and valuable.

The first element of this new and novel system and method relates to Trademark Status Watches which depend on searches of a PTO's databases, and particularly to multiple marks searches. When there is a desire to learn the status of a mark listed in the a PTO's database, such as the USPTO's Online Trademark Application and Registrations Retrieval (“TARR”) database, it is necessary to navigate to the Status Check section, enter into the appropriate box the reference number corresponding to the mark, and then it is necessary to “click” the “Request Status” button. To perform a Status Check of a Registered Mark, either the Application Serial Number or the Registration Number needs to be entered. This restrictive, single-reference number entry section solely indicates the status in the database of one single mark. Since multiple marks may not be entered, this search method is not conducive to multiple marks searching. This is a decidedly disadvantageous condition, particularly for an attorney who represents multiple marks and who wishes to know on a daily basis any status change relating to any of the marks on his or her watch list. The requirement to enter a reference number for a single record, and to subsequently open each record and check its status individually can be extremely time-consuming, and even fatiguing. The fatigue factor may even be worse than the time-consuming aspect of such a Status Check method, since fatigue increases chances for the commission of errors which could result in the “checker's” misinterpretation of the actual status of a mark.

A “workaround” means to ascertain the status of multiple marks exists. This is to say, a means not necessarily initially devised to be used in this manner exists, and it entails proceeding to and searching in the Trademark Electronic Search System (“TESS”) section, instead of searching in the TARR Status Check section. In the TESS database, a group of reference numbers collected from, for instance, a word processing program, may be “cut” or “copied”, and then “pasted” into the Boolean Search. However, this method does not obviate the need still to open and then actually check one-at-a-time each record in the resulting list of records that is generated by performing a search using this method. Rather, the Boolean Search merely facilitates, to a slight degree, the laborious steps of Status Checking by obviating the need for every reference number to be individually entered in the TARR database for Status Checking. Of course, the reference numbers must still be fully and correctly entered in and saved at least once in a word processing program. The fact that using this method still does not offer any immediate indication of any changes in status for searched marks underscores its primary disadvantage.

A superior method for determining the daily status of multiple marks, which requires not even the slightest daily effort on the part of any USPTO employee, not even the Examiner, is disclosed herein and requires changes to a PTO's Online Status Check program software. The value to enhancing the software in the manner disclosed herein is substantial. Any company, individual, attorney (or paralegal working on behalf of an attorney or attorneys) generally desires to check the status of multiple marks on a daily basis in order to learn the most-up-to-date status of marks. Whereas some docketing programs will automatically remind users of upcoming due dates, these docketing programs can not provide the most recent, daily status of a mark because docketing programs are not interactive with the USPTO's proprietary database. Docketing programs, so far, have never requested and then been granted rights to automatically connect to each other so that new status changes can be, effectively automatically uploaded, at the instigation of the external, commercial entity's docketing software so that the software program can connect with and “read” and record the status change results. Docketing programs are reactive, not proactive.

Typically today, a corporation or law firm assigns an in-house paralegal to do a Daily Trademark Status Watch. Alternatively, one of a dozen or more professional search firms which now exist in North America can be engaged. If multiple marks need to be checked, however, fees charged by a professional search firm for a daily Status Watch for a single mark, let alone multiple marks, can become very expensive. It is particularly noteworthy that the Status Watch services provided by professional search companies pay no fees to the USPTO, and therefore, the USPTO earns no profits from searches of the database it works hard to compile and maintain.

This disclosure includes a PTO's potentially fee-based service for checking the status of marks, which service may be initiated by an applicant or other interested party. The applicant can elect to pay the full fees for search services at the time of filing, or the applicant or other interested party may have the option of choosing to pay at any later date. In fact, since the TARR database information is a public record, it is likely that someone who is NOT the applicant, but rather and adversary or Opposer of a mark would gladly to pay search fees to activate a PTO “Status Watch” service. Thus, one mark may generate multiple payments from the applicant as well as multiple Watch subscribers who are all monitoring the status of a single mark.

Another element of this disclosure relates to the introduction of a saleable pool of patents in a “Secondary Expiration” grace period. Currently, when a patent maintenance fee is not paid, there is a grace period that offers, effectively, an extension of time to pay the maintenance fee. This patent maintenance fee grace period is six months. When this grace period expires, the patent expires. It is virtually non-revivable. The USPTO loses access to the just-expired maintenance fee, as well as to any remaining maintenance fees which would have been paid in the future had the patent not irrevocably expired. Moreover, the interest in and chance for an apparatus disclosed in a patent to be exploited also dwindles because the value monopoly that the patent affords is lost.

There is a vested interest by a PTO to promote the maintenance of the patents it grants. This disclosure reveals the system and method by which, if a patent owner does not pay the maintenance fee on a patent, and the first (traditional) patent grace period passes, a second, 6-month grace period commences in which someone else, including the owner, on a “first-come, first served basis” can pay the USPTO the fees for the patent rights for the duration of the statutory life of the patent. All patent rights would still be enforceable during the secondary grace period. Preferably, the traditional grace period would be extended six months. Alternatively, the traditional grace period could be moved six months earlier than it traditionally has been instituted. The payment to, essentially, “purchase” the patent from the PTO for the cost of the maintenance fees would be made all at once, with the option to pay over time to be decided on a case-by-case basis. The PTO costs for assigning the rights to a new owner would also be passed on to the new assignee. There would be no royalty to be paid to the original patent owner or last assignee since he, she, or it, effectively, would have abandoned any rights to the patent by not paying the maintenance fee during the Window Open period during the first grace period. Prospective technology exploiters would be able to browse a listing of patents in the secondary grace period, and an auction system could even be developed.

Yet another aspect of this disclosure relates to the Online Trademark database which is accessible by the general public, and which does not indicate, but which should indicate the exact date by which a Maintenance fee is due for a mark and what the current status is for the maintenance of a mark. Moreover, this disclosure offers the new and novel concept that during the grace period for paying the maintenance fee for a registered trademark, no activity or fees will be accepted by a PTO towards the registration, such as the acceptance of the filing of a Section 15 Affidavit, until the Maintenance fee and penalty fee are paid, thereby giving the registration a “current” status in “good standing.” USPTO employees charged with processing applications and accepting fees would check the status of U.S. Trademarks, and inform a registrant with registered trademark in its grace period that no fees or can be paid for and no activity/actions may be taken relating to a mark in its grace period until maintenance fees are fully paid, thereby putting the mark in “current and good standing” status.

Furthermore, within the TARR database of the USPTO, a distinction is made between the listed “CORRESPONDENT” for a mark, and the attorney of record. This becomes problematic when a file is transferred from either an individual (non-attorney individual) or a corporation to an attorney. In this circumstance, the new attorney must file a Power of Attorney (POA) for all the marks he or she inherits. The new attorney must wait for the POAs which are not permitted to be submitted electronically, but rather, may only be mailed or faxed, to be uploaded to the appropriate TARR records before any eTEAS work can be legally accomplished. The reason this can be problematic relates to electronic filing/recording since any requests/grants for extensions of time to file, for instance, are not able to be recorded if the attorney selects the radio button at the very beginning of the filing process indicating that the filing is being done by an attorney—as the attorney should! The reason for this is that the TARR database does not recognize that an attorney is associated with the record, and therefore prevents the recognizing of the attorney submission, if the Attorney of Record has indicated that the filing is being done by an attorney.

In contrast to this condition, a Change of Correspondent filing can be accomplished electronically, and such a change is usually relatively quickly reflected Online. In TEAS application filings, a section requesting an email address for an applicant states that only one email address may be used for correspondence per application. If an attorney has POA over an application, then the Correspondent Address should only be able to reflect that of the attorney, and not that of the mark owner or any previous Attorney of Record. The correspondent address should not be able to be an address other than that of the current attorney having a signed POA. The fact that the attorney of record at the time the trademark issues is forever associated with the original trademark registration document has little import and is less consequential than the name of the current Attorney of Record. Moreover, if the USPTO honor system can be trusted for the change in Correspondence for a mark, then why should the same honor system not be put in place for a change in POA? The simple solution would be the attachment to the file of a .jpg or .pdf, or some alternative file formatted image of the POA which, like the .jpg image of the mark, can be seen by the public and associated with the application of a respective mark.

If a POA is accepted, then, by default, the Correspondent Address must be that of at least one attorney indicated in the POA. Conversely, if Correspondent Address can be changed electronically, an indicator button should be made available so that the TARR database can immediately reflect the change that a new attorney is handling the case. For both pending and registered marks, it should be possible to pay a fee to immediately have an updating change reflected in the Online database so that the correct information pertaining to a mark is displayed. The fee could be ⅓-½ the cost of the prevailing recordation fee. In doing so, fees for USPTO would be generated, and also attorneys might more easily keep clients, since clients might conceivably be less inclined to switch attorneys frequently if there were recording fees incurred for doing so. A customer number system could also be established. It would have two sections, one indicating the owner of the registration or application, and one section relating to the correspondent. The correspondent information would be a number representing an entity or attorney, not “licensed” to practice before the USPTO, but simply “on record”. The entity would have its contact records on file. Thus, the correspondent information would read “123456987654-04-NJ”, representing the year the correspondent registered for a number, and the state to which correspondence would be mailed. Should the responsibility for this mark transfer to another attorney or entity, only the new number would need to be re-typed. The actual database would be programmed to read the number and automatically display the appropriately associated correspondent information. This would speed the updating of database information since data-entry workers would need to type less information, would make fewer mistakes because less information to enter, and could concentrate their efforts on simply recording the number correctly. The entry could easily be checked by the second stage of data-entry by a typist, or preferably, a computer program which would match the application serial number and the displayed correspondent information against the information contained in the request to change correspondent. A further fee would be generated by the USPTO for registration of contact information with the USPTO. This condition, revealed in this disclosure, is a new and novel one in which fees may be paid to a PTO for expedited, most accurate reflection of status in the Online databases.

The development of computer design software suitable for use by the general public is only slightly more than a decade old. During the inventing process, people don't use notebooks to the same degree that they once did. Instead they use CAD/CAM software as well as computer illustration programs such as Illustrator and Coreldraw. This development, coupled with the prevalence of home computers and scanners now offers the opportunity for the USPTO to generate new revenues by offering inventors the chance to establish an account on a server to which they can email and thereby record the date and time of their developments in an “un-fudgeable” manner.

In this manner, the greatest proof of timeline of inventorship could be proven beyond a reasonable doubt, and greater credence in the courts could be lent to “submitted” and “date-stamped” developments as a means to encourage the submission of developments along a timeline. Any submissions would never be seen, and would simply be used as a repository to establish the earliest date of invention. This could be an important factor in settling interferences. This would not be a provisional patent, it would simply officially log the stages of development, the way an inventor's notebook would log the timeline of development. These NW accounts would generate new jobs within the PTO, new revenues from the establishment of accounts, and greater security for inventors since a large corporation would not be able to prevaricate in court by swearing back to an earlier date of invention to edge-out a small inventor's efforts.

There has never before been any product developed, nor has there been any prior art disclosed to suggest the information of this disclosure.

### SUMMARY AND OBJECTS OF THE DISCLOSURE

The present disclosure provides for a system and method for generating new revenues for a PTO, while at the same time enhancing use of a PTO's services for those who wish to avail themselves of such services.

One of the objects of this disclosure is to provide a system which offers stellar service to those interacting with a PTO by automatically checking PTO patent and trademark databases for changes in status. These status checks are accomplished by taking a pre-collected grouping of serial numbers submitted to a PTO “STATUS CHECK ACCOUNT”, and automatically checking them against a pool of recently changed serial number records to determine if a match can been made. The purpose of this is to avoid an interested party's need to check an entire database for any changes. Only the serial numbers of records saved (meaning opened by an authorized PTO Examiner and saved due to a recorded change in status) within a pre-determined time period, for instance, an hour period would need to be checked. Since such a pool of serial numbers would be smaller than the entire database, checks could be performed more expeditiously. The resulting identified changed serial numbers and their identifying word marks could then be emailed to the designated recipient of the search results.

Another of the objects of this disclosure is to encourage more people to file electronically by offering to small inventors the opportunity to make payments through deposit accounts requiring a mere US$1 minimum balance and no penalty whatsoever for falling under the $1 minimum balance. This would permit a PTO to have access to even greater funds to generate banking-type interest. If the USPTO can create a customer number for an applicant who has only one application, then surely it can also create a deposit account for such a customer. To cover any additional costs or efforts to create such an account, a $25, one-time processing charge could be assessed. This would permit someone without a credit card or someone having a credit card but unwilling to furnish credit card information, perhaps due to identity-theft concerns, to still be able to file electronically. The benefits of electronic filing include less paperwork for a PTO, and a faster reflection of up-to-date information in PTO databases. Every effort should be undertaken to encourage electronic filing by any and everyone, not merely those having the financial resources permitting the maintenance of a US$1000, non-interest-earning, USPTO Deposit Account balance.

Another object of this disclosure is to enhance the factual, up-to-date data contained in a PTO database. Currently, in the USPTO, changes to correspondence and assignment information is not immediately reflected in the TARR database, despite acceptable payments and forms relating such changes to the USPTO. Changes are updated whenever the next opportunity exists for an Examiner to review the application to be changed. This circumstance does not reflect well on the USPTO. Inexpensive talent can be hired in Philippines, a country in which most people speak English, and many speak as well as American citizens, to update this information on a daily basis. Additional fees may be assessed on those willing to pay extra to have correct information updated immediately upon notice of a change being submitted in a format acceptable to the USPTO for recordation.

Still another object of this system is an indicator for U.S. Trademarks that a mark has expired and that it is in the “Grace Period.” This indicator is in the interests of the USPTO which loses significant revenues when a mark is cancelled for Section 8 reasons when the Applicant simply inadvertently did not make a maintenance payment. A Registrant who has not stopped using a Registered mark should be able to pay a hefty fee to re-instate a mark, thereby preserving years of established efforts and rights to a mark, and further generating whopping fees from assessed penalties. With the current USPTO policy, not only does the USPTO hurt the business of the Registrant, but further, it misses out on generating substantial revenues from penalties, and it also loses all FUTURE maintenance fees! The system of this disclosure provides for enormous new revenues for the USPTO.

Yet still another object of this system is the disclosure to the general public of the exact date by which a Maintenance fee is due to be paid for a registered trademark.

Yet another, still further object of this system is the implementation of an electronic Inventor's notebook, which would be maintained by the USPTO as proof of the date of invention, and for which only a nominal annual fee would be charged. This way, large oligopoly corporations would not be able to claim prior development, and therefore “ownership” to a smaller inventor's apparatus. This way, smaller inventors who do the job that huge companies should do would enjoy superior protections in presenting new devices to larger corporations which “control” the marketplace due to the government's recent reluctance to enforce anti-trust regulations.

Part of this system includes the development of a position dedicated to the development of new revenue-generating opportunities for a PTO.

### BRIEF DESCRIPTION OF THE DRAWINGS

FIG. 1 discloses synching software linking a PTO database with a docketing program which can automatically download changed/updated info into the appropriate location;

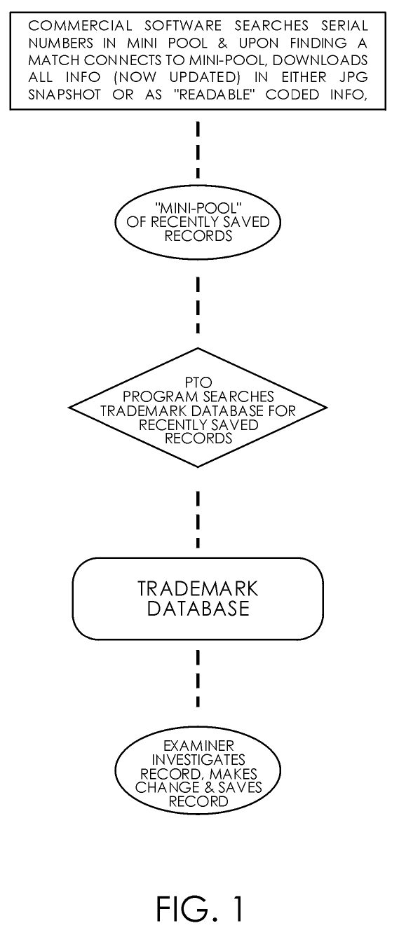

FIG. 2 discloses system to check status and deny actions, apart from payment of trademark registration maintenance fee, and to inform general public regarding the exact date that a trademark maintenance fee is due;

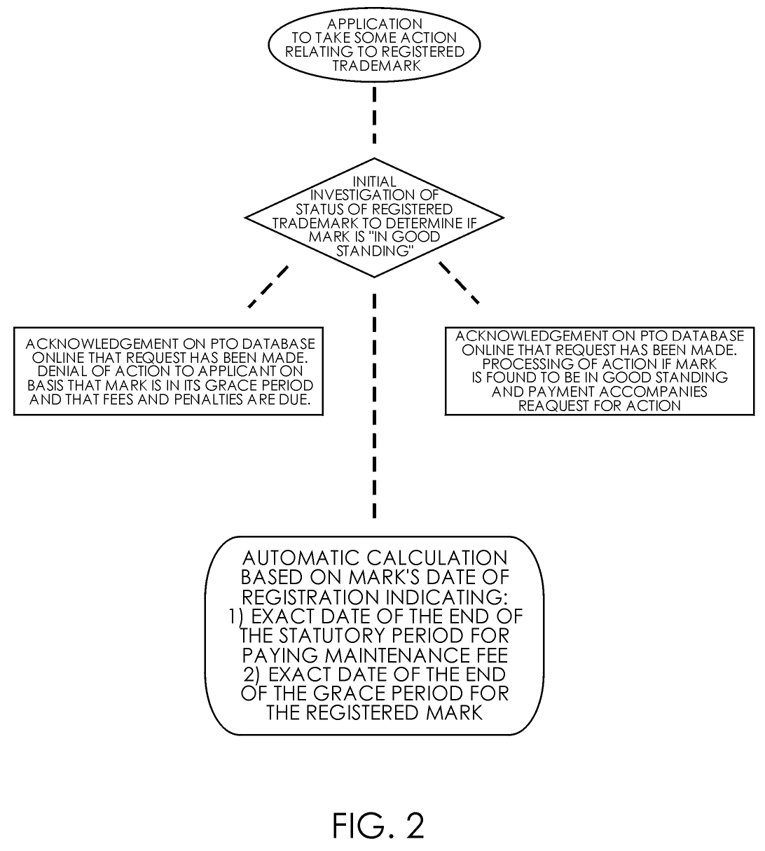

FIG. 3 discloses a system for permitting a secondary grace period during which a patent owner or third party may pay the remaining maintenance fees for, and thereby take ownership of a patent whose maintenance fees were not paid during the traditional grace period;

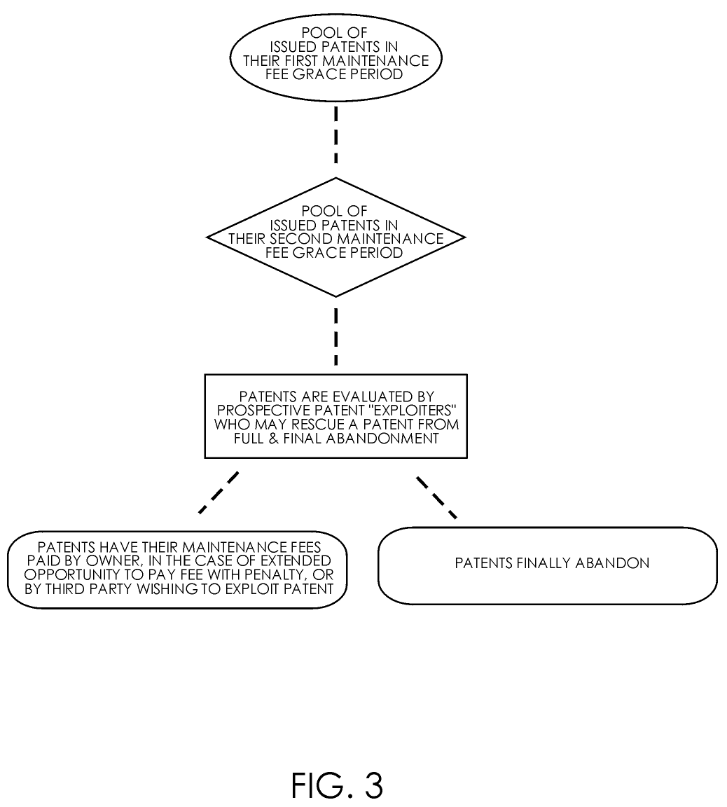

FIG. 4 discloses an enhanced trademark search method;

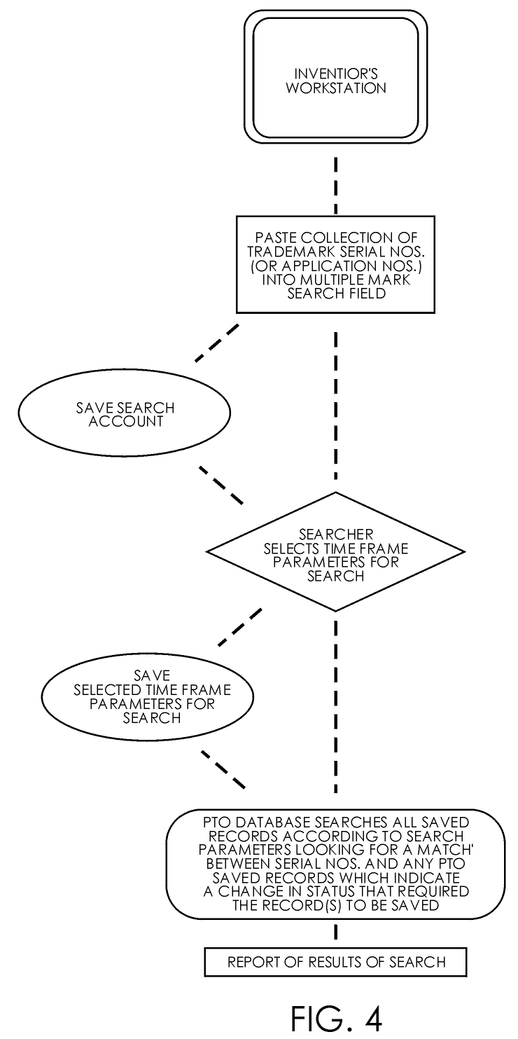

FIG. 5 discloses an electronic inventor's notebook registry.

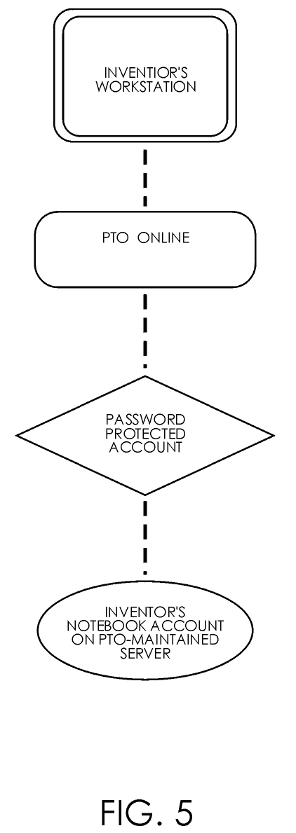

### DESCRIPTION OF THE PREFERRED EMBODIMENT

In the preferred embodiment of this disclosure, a superior method for determining the daily status of multiple marks, which requires not even the slightest daily effort on the part of any USPTO employee, not even the Examiner, is disclosed herein and requires changes to a PTO's Online Status Check program software.

Part of the changes to the software would include an indication that the trademark record was opened and changed. The indication would register upon the saving of any status change within the database. The saving of a record implies the recording of some action which required or merited saving. Such an action would, therefore, deserve the attention of someone following the progress of a pending or registered mark-someone such as the Attorney of Record. Even in the instance in which the record of a mark was opened by a USPTO employee and mistakenly saved with no action taken, even this event could be of interest to the responsible person following the status of a mark.

The steps in a method of this system could be the saving of information in a PTO database; the programming of a software to recognize the day and date an investigative scan is being performed of a database; an investigative scan by a software program of all records as part of a search for any re-saved records which would have been saved in the pre-determined time period, such as a one-hour period, prior to the search; such a scan to be performed at least once a day, but preferably at least once each hour; a “culling” of the records changed within the previous hour into a pool of recently “saved” records; a “flag” being associated with these records indicating a distinguishing between these and other records not recently re-saved; a category section of the database which would display the “flag” when a search including the number of the flagged record is made; the ability to display only the flagged records of serial numbers when a search of multiple serial numbers is undertaken; the opening of the record directly from the results of such a search and the turning of another shade of a color after a record has been opened to indicate that the flagged record was already opened; the ability to email the flagged results of a search of multiple serial numbers.

The establishment of a software which automatically takes a set of serial numbers from a pre-established account; searches to find if any saving of the record associated with that serial number has been accomplished since the last search; if finding a newly saved record, searches for the mark associated with that serial number, records the serial number and mark into a pool; emails the results to the email address associated with the account for which the initial search was performed.

This disclosure includes an initiatable service for checking the status of a mark, for which an applicant has paid an additional fee at the time of filing or which he or she may elect to subscribe to and pay for at any later date. A subscriber would pay for a Watch Account, receive a User ID and Password and then would be able to access the USPTO SUPER SEARCH database system having the coded “flags”. In fact, since the TARR database information is effectively a public record, it is possible even for one who is NOT an applicant, but rather and adversary or Opposer of the mark to pay a fee to activate the “Watch” service. One mark may generate multiple payments from multiple Watch subscribers following a single mark.

When an applicant electronically attempts to file a post-registration activity, the PTO trademark database checks the status of the mark; if the calculations of the PTO database interpret that the registration is in its Grace Period, the electronic filing prevents the activity from being accomplished until the registration has been made in good standing and notice of the Grace Period status is mailed and emailed to the Registrant, since this is so important, and even a phone call is initiated for which the Registrant gets charged if the registration is renewed, so that the PTO has done all it can to alert the Registrant regarding the status of the mark.

This disclosure is a novel system and method. While preferred embodiments of the present disclosure have been described and illustrated using specific terms, such description is for illustrative purposes only. It may be appreciated and understood that many changes and modification of the disclosure as described herein may be made by a person skilled in the art to which this subject matter pertains without substantially deviating from the spirit and scope of the disclosure and of the following claims. As the preferred embodiment is capable of variation, addition, omission and modification without departing from the spirit and scope of the disclosure, consequently, it is not the intention of the applicant to limit his disclosure to those modes and embodiments of the disclosure shown or described above. Protection is desired for all changes and modifications that come within the spirit of the disclosure.

What is claimed is:

1. System and method for improving a Patent and Trademark Office comprising:
at least a database
means for searching said at least a database.

2. System and method for improving a Patent and Trademark Office comprising:
at least an electronic database;
means for searching said at least an electronic database;
means for creating and account and living information on said at least an electronic database.
